(19) United States
(12) Patent Application Publication
(10) Pub. No.: US 2010/0157720 A1
(43) Pub. Date: Jun. 24, 2010

(54) Vibration Enhanced Mixing Process

(76) Inventors: Michael Woodmansee, Houston, TX (US); Philip Zsiga, Tulsa, OK (US); Josh Rayner, Houston, TX (US); Rod Shampine, Houston, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/339,194

(22) Filed: Dec. 19, 2008

(51) Int. Cl. B28C 5/48; B01F 11/02; B28C 7/16

(52) U.S. Cl. 366/6; 366/108; 366/51

(57) ABSTRACT

A method for mixing a slurry for delivery to a downstream point comprises mixing a liquid source and a powder source at a mixing location to form the slurry, directing the slurry to at least one of a downstream point and a recirculation circuit, and introducing at least one vibration source to promote slurry homogenization and thorough mixing of the slurry for delivery to the downstream point, the vibration source located remote from the mixing location.

### BACKGROUND

The statements in this section merely provide background information related to the present disclosure and may not constitute prior art. The system and method relate in general to wellsite surface equipment such as, but not limited to, cement mixing equipment and the like.

Cement slurries in oilfield cementing systems are typically pumped between a casing and the earth during the construction of an oilwell to, for example, ensure zonal isolation between geologic formations and the like. The slurry preferably consists of a precise proportion of dry cement blend and mix fluid that performs best when fully homogenized in order to obtain desired properties of the slurry, which may include, but are not limited to, density, viscosity, fluid loss, free water, gelling time, hardening time, hardened strength and gas permeability. The slurry is often formed by mixing the dry cement blend and the mix fluid in a continuous mixing process. For practical purposes, the slurry is fully mixed when all solid particles have been wetted and dispersed in the mix water and all air has been removed from the slurry. Once the slurry is fully mixed, it is pumped at a pre-determined rate into the wellbore. In order for the cementing operation to be successful, the continuous mixing process must produce well-mixed slurry as quickly as possible. The wetting, gelling and hardening processes of cement slurry are time-dependent; failure to homogenize the slurry soon after initial contact with the mix fluid may disadvantageously cause the formation of clumps and foam, which further complicate both the mixing and pumping processes and can result in failure to meet the objectives of the cementing job.

Air ingestion and retention in the slurry is a major problem in the continuous mixing of certain slurry formulations. The continuous mixing problem may no longer continue when the air retention in the slurry becomes so high that the recirculating pump no longer generates adequate flow to support the mixing system. A failure in the continuous mixing system can result in significant lost time and money associated with the cementing job. Batch mixing is typically prescribed for the most difficult to mix formulations; however, the size of the batch mixing equipment may limit the total job volume possible and may increase the total cost of the job.

It is always desirable to improve the operation of wellsite surface equipment, including continuous mixing cementing equipment and the like.

### SUMMARY

A method for mixing a slurry for delivery to a downstream point comprises mixing a liquid source and a powder source at a mixing location to form the slurry, directing the slurry to at least one of a downstream point and a recirculation circuit, and introducing at least one vibration source to promote slurry homogenization and thorough mixing of the slurry for delivery to the downstream point, the vibration source located remote from the mixing location. Alternatively, introducing comprises introducing the vibration source in at least one of a location between the mixing location and the downstream point and a location in the recirculation circuit. Alternatively, the system comprises a wellbore cement slurry mixing system, the downstream point comprises a wellbore, directing comprises directing the slurry to the wellbore, and introducing comprises introducing the vibration source in at least one of the mixing system and the recirculation circuit. Alternatively, the method further comprises providing a liquid source and at least one powder source for forming the slurry.

Alternatively, the liquid source comprises a water-based liquid. Alternatively, the liquid source comprises water and at least one liquid additive. Alternatively, the powder source comprises a blend of dry cement. Alternatively, the powder source comprises a dry cement blend and at least one dry particulate additive. Alternatively, the vibration source comprises an active vibration source. Alternatively, the vibration source comprises a passive vibration source. Alternatively, introducing the vibration source promotes slurry homogenization by enhancing wetting of the powder source in the liquid source of the slurry. Alternatively, introducing the vibration source promotes slurry homogenization by removing air from the slurry. Alternatively, introducing comprises introducing vibration in at least one of a high-velocity zone between the mixing location and the downstream point and a high-velocity zone in the recirculation circuit.

In an embodiment, a system for mixing and delivering a slurry to a downstream point, comprises a mixing location for mixing a liquid phase and a powder phase to form the slurry, a pump for directing the slurry to at least one of a recirculation circuit and the downstream point, and at least one vibration source to promote slurry homogenization and thorough mixing of the slurry for delivery to the downstream point, the vibration source located remote from the mixing location. Alternatively, the liquid phase comprises a water-based liquid. Alternatively, the liquid phase comprises water and at least one liquid chemical additive. Alternatively, the powder phase comprises a dry cement blend. Alternatively, the powder phase comprises a dry cement blend and at least one dry chemical additive.

Alternatively, the vibration source comprises an active vibration source. Alternatively, the vibration source comprises a passive vibration source. Alternatively, the vibration source promotes slurry homogenization by enhancing wetting of the powder source in the slurry. Alternatively, the vibration source promotes slurry homogenization by removing air from the slurry. Alternatively, the system comprises a wellbore cement slurry mixing system, comprising at least a mixer, a slurry air separator, a mix tub, a recirculation pump, and a delivery pump, and wherein the downstream point comprises a wellbore. Alternatively, the at least one vibration source is located in a high-velocity zone in at least one of the recirculation circuit and the system.

Embodiments of systems and methods enhance the mixing of a powder source and a liquid source to form a slurry, for example cement slurry, by employing forced vibration inside or outside of the process piping or other high-velocity zones.

### BRIEF DESCRIPTION OF THE DRAWINGS

These and other features and advantages of the present invention will be better understood by reference to the following detailed description when considered in conjunction with the accompanying drawings wherein:

FIG. 1 is a schematic view of a slurry mixing system.

FIG. 2 is a schematic view of an active vibration source for use with the system of FIG. 1.

FIG. 3 is a schematic view of an active vibration source for use with the system of FIG. 1.

FIG. 4 is a schematic view of an active vibration source for use with the system of FIG. 1.

### DETAILED DESCRIPTION

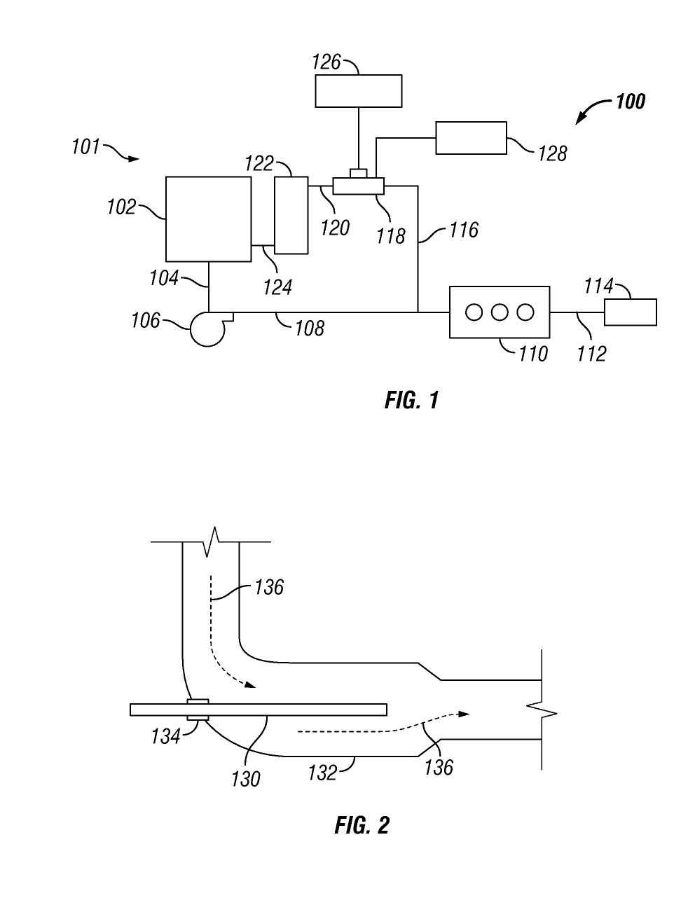

Referring now to FIG. 1, a system for continuously mixing a slurry of powder and liquid is indicated generally at 100. The slurry may be, for example, a cement slurry for use in a wellbore cementing operation. The system 100 comprises a mix tank 102 having slurry disposed therein that is in fluid communication via a conduit 104 with a recirculation pump 106, such as a centrifugal pump or the like. The pump 106 pressurizes the slurry and discharges it to an outlet or conduit 108, which is in fluid communication with a delivery pump 110, such as a positive displacement triplex pump for pumping slurry to a wellbore. An outlet or conduit 112 of the pump 110 extends to a downstream point or destination, indicated generally at 114, such as a wellbore (not shown) or the like. A recirculation line or conduit 116 is in fluid communication with the outlet 108 of the pump 106 and a jet mixer 118. An outlet or conduit 120 of the jet mixer 118 is in fluid communication with an optional slurry air separator 122 which may be a hydrocyclone-type separator, such as that shown in commonly assigned and copending application Ser. No. 11/996,087, incorporated by reference herein in its entirety. An outlet or conduit 124 of the optional slurry air separator 122 is in fluid communication with the mix tank 102. The outlet or conduit 124 may comprise a nozzle (not shown) used to inject the cement slurry into the mix tank 102. The system 100 may comprise a direct connection, such as through a conduit or the like, between the mixer 118 and the mix tank 102 without the use of a slurry air separator 122. The recirculation line 116, the mixer 118, the slurry air separator 122, the mix tub 102, and the pump 106 form a recirculation circuit of the system, indicated generally at 101. The recirculating circuit 101 of the system 100 has the dual function of sending mixed slurry to the delivery pump 110 or pumps and returning slurry back through the mixer 118 in order to provide a motive force that facilitates the further mixing of cement blend and mix water, discussed in more detail below. The downstream point 114 may be any location or destination remote from the system 100 or recirculating circuit 101, such as a wellbore penetrating a subterranean formation or the like.

Flow of the slurry throughout the system 100 generally comprises flow from the mix tank 102, to the conduit 104, through the pump 106, through the outlet 108, through either the pump 110 and the outlet 112 to the downstream point 114 or to the recirculation circuit 101 via the recirculation line 116 to the mixer 118. From the mixer 118, the slurry flows through the outlet 120 to the optional slurry air separator 122, through the outlet 124 and back to the mix tank 102.

The system 100 shown in FIG. 1 shows only the flow of slurry through the system 100. A source or phase of powder 126 and a source or phase of liquid 128 are introduced at the mixer 118 to form additional slurry to replace the slurry routed to the downstream point 114. The mixer 118 may be a jet mixer or similar mixer, as will be appreciated by those skilled in the art, such as that shown in commonly assigned and copending application Ser. No. 12/117,831, incorporated by reference herein in its entirety, and may comprise a nozzle for recirculating slurry and an eductor at the mixer discharge. The source of powder 126 may be a dry cement blend, typically comprising, but not limited to, Portland cement or the like as well as various dry additives, such as dry particulate additives used in cementing operations and other components that enhance the performance of the cement slurry in its liquid, gelled or hardened form including, but not limited to, extenders, weighting agents, fluid loss control, anti-foam, silica, flexible particles, accelerators, retarders, combinations thereof and the like. The source of liquid 128 may be mix water, comprising water and various liquid additives, such as liquid chemical additives used in cementing operations including, but not limited to, extenders, anti-foam, defoamer, accelerators, retarders, gas migration inhibitors, thickening agents, combinations thereof and the like. The source of powder 126 including any additives and the source of liquid 128, including any additives, are added to the recirculating slurry jet or mixer 118 to form additional slurry for the system 100. The optional slurry air separator 122 advantageously removes air entrained in the slurry system during the mixing process at the mixer 118.

The performance of the system 100, especially with respect to forming a homogenized slurry mixture, is enhanced by introducing at least one source of vibration to the system 100 in order to promote slurry homogenization and thorough mixing of the slurry for delivery to the downstream point 114. A vibration source may be introduced at various locations within the system 100 including at the conduit 104 between the mix tank 102 and the centrifugal pump 106. In this location, the vibration source reduces effective slurry viscosity and separates out entrained air before the slurry enters the centrifugal pump 106. The fluid velocity within the conduit 106 prevents the slurry from gelling as the dry cement is wetted more completely.

A vibration source may also be introduced at the recirculation line 116 between the centrifugal pump 106 and the mixer 118. The fluid velocities in the recirculation line 116 will be higher than within the suction line or conduit 104 of the centrifugal pump 106, further preventing the slurry from gelling during recirculation. A vibration source may also be introduced at the outlet 108 between centrifugal pump 106 and the downstream pump 110. The vibration introduced at the outlet 108 vibration may enhance filling and/or reduce the net positive suction head required with cement slurry.

A vibration source may also be introduced at a location within the mixer 118. The vibration source may be installed within the nozzle of the jet mixer 118 to produce a jet stream with vibratory energy or downstream of the nozzle at the eductor. In each location, mixing is enhanced because the vibratory energy imparted to the flow enhances wetting of the powder source, such as dry cement blend. A vibration source may also be introduced at a location within the slurry-air separator 122. The vibration source may enhance air removal from the slurry and, if a cyclonic-type separator is used, then the high velocities attained within the cyclone will prevent gelling in the slurry.

A vibration source may also be introduced at outlet 124 between the slurry-air separator 122 and the mix tub 102. The vibration source may be installed to enhance incorporation of any remaining dry cement pockets and finalize air removal from the slurry as it is injected in the tub 102. The velocity of the slurry as it passes through the nozzle used to inject the cement slurry into the mix tub 102 will prevent the slurry from gelling.

The vibration source introduced at any of the above-mentioned locations may comprise an active vibration source. An active vibration source comprises a vibration source wherein the source of energy is external to the system 100 or external to the flow in the system 100. Examples of an active vibration source comprise, but are not limited to, a commercially-available concrete vibrator which produces an output ranging between about 8,000 and about 20,000 vibrations or cycles per minute (vpm) or vibration in any suitable range. The active vibration source may also comprise any other type of pneumatic, hydraulic or electric vibrator that produces, for example, an output as low as about 3000 vpm or vibration in any suitable range.

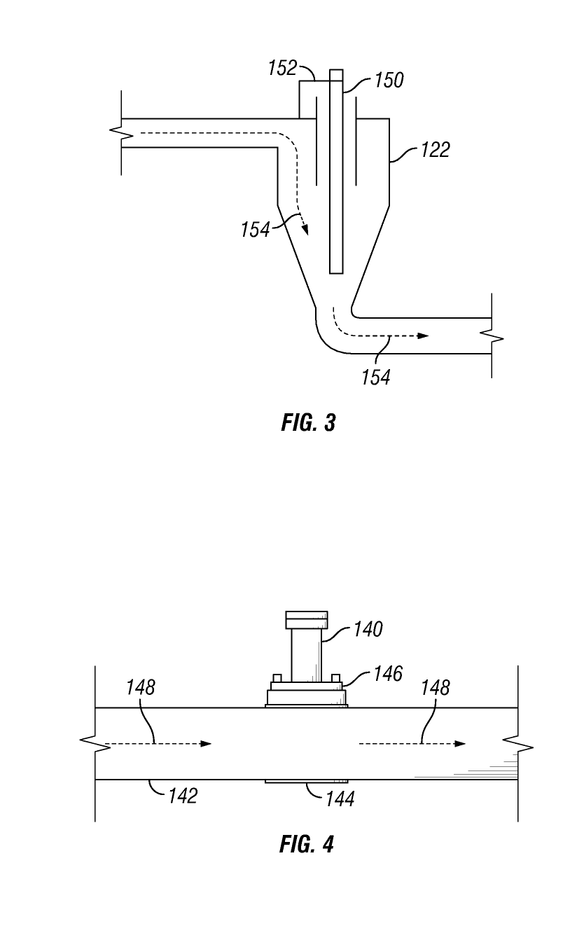

The active vibration source may be inserted into the piping using a welded coupling or similarly attached. An embodiment is shown in FIG. 2, wherein a vibration source 130 is mounted inside a conduit 132 utilizing a coupling 134 or any suitable mounting device. The vibration source 132 may be a concrete vibrator or the like and may be installed in the conduit 134 at a reducing elbow or similar location where flow velocity increases, which will enable the vibration source 132 to enhance mixing and homogenization of the slurry, indicated by flow arrows 136, within the conduit 134. Referring to FIG. 3, a vibration source 150 is shown attached to a slurry air separator, such as the slurry air separator 122 by a mounting bracket 152 or any suitable mounting device. The vibration source 150 may be mounted to an exterior surface of the slurry air separator 122 and extends into the body of the slurry air separator 122 to enhance the mixing of the slurry, indicated by flow arrows 154 and remove entrained air in the slurry.

The active vibration source may be mounted to the outside surface of the piping or vessel itself using a clamp, adhesive, welding or any other method of mounting. Referring to FIG. 4, a vibration source 140 is shown attached to an exterior surface of a conduit 142 utilizing a pipe clamp 144 and mounting device 146. The vibration source 140 enhances mixing of the slurry, indicated by flow arrows 148. As noted above, the vibration source may be mounted utilizing bolting, welding, adhesion or any other suitable method of mounting.

The vibration source introduced at any of the above-mentioned locations may comprise a passive vibration source. A passive vibration source comprises a vibration source, wherein the fluid pump is the root source of vibrational energy. The passive vibration source may be a throttling device in one of the conduits 104, 108, 116, 120, or 124, or a loosely supported pipe or conduit 104, 108, 116, 120, or 124. The passive vibration source may also comprise a design of the pipework, such as the conduits 104, 108, 116, 120, or 124, such that the pipework or conduits have a resonant frequency that matches a driving frequency in the environment of the recirculation circuit 101 or system 100.

Embodiments of the system 100 and method advantageously apply vibration from the active or passive vibration sources at locations where the flow velocity creates sufficient turbulent shear to avoid the excessive gelling that results in higher apparent viscosity of the slurry, such as cement slurry. Embodiments of the system 100 and method advantageously promote thorough mixing and homogenization of the slurry by enhancing wetting and removing air from the slurry. The vibration source enhances wetting of the powder source and the liquid source and advantageously promotes the rejection of air bubbles when the slurry is introduced to a free surface for air rejection, such as in the mix tub 102, the mixer 118, the slurry air separator 122, and the like.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values. Accordingly, the protection sought herein is as set forth in the claims below.

The preceding description has been presented with reference to presently preferred embodiments of the invention. Persons skilled in the art and technology to which this invention pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

What is claimed is:

1. A method for mixing a slurry for delivery to a downstream point, comprising:
mixing a liquid source and a powder source at a mixing location to form the slurry;
directing the slurry to at least one of a downstream point and a recirculation circuit; and
introducing at least one vibration source to promote slurry homogenization and thorough mixing of the slurry for delivery to the downstream point, the vibration source located remote from the mixing location.

2. The method of claim 1 wherein introducing comprises introducing the vibration source in at least one of a location between the mixing location and the downstream point and a location in the recirculation circuit.

3. The method of claim 1 wherein the system comprises a wellbore cement slurry mixing system, the downstream point comprises a wellbore, directing comprises directing the slurry to the wellbore, and introducing comprises introducing the vibration source in at least one of the mixing system and the recirculation circuit.

4. The method of claim 1 further comprising providing a liquid source and at least one powder source for forming the slurry.

5. The method of claim 1 wherein the liquid source comprises a water-based liquid.

6. The method of claim 1 wherein the liquid source comprises water and at least one liquid additive.

7. The method of claim 1 wherein the powder source comprises a blend of dry cement.

8. The method of claim 1 wherein the powder source comprises a dry cement blend and at least one dry particulate additive.

9. The method of claim 1 wherein the vibration source comprises an active vibration source.

10. The method of claim 1 wherein the vibration source comprises a passive vibration source.

11. The method of claim 1 wherein introducing the vibration source promotes slurry homogenization by enhancing wetting of the powder source in the liquid source of the slurry.

12. The method of claim 1 wherein introducing the vibration source promotes slurry homogenization by removing air from the slurry.

13. The method of claim 1 wherein introducing comprises introducing vibration in at least one of a high-velocity zone between the mixing location and the downstream point and a high-velocity zone in the recirculation circuit.

14. A system for mixing and delivering a slurry to a downstream point, comprising:
a mixing location for mixing a liquid phase and a powder phase to form the slurry;
a pump for directing the slurry to at least one of a recirculation circuit and the downstream point; and
at least one vibration source to promote slurry homogenization and thorough mixing of the slurry for delivery to the downstream point, the vibration source located remote from the mixing location.

15. The system of claim 14 wherein the liquid phase comprises a water-based liquid.

16. The system of claim 14 wherein the liquid phase comprises water and at least one liquid chemical additive.

17. The system of claim 14 wherein the powder phase comprises a dry cement blend.

18. The system of claim 14 wherein the powder phase comprises a dry cement blend and at least one dry chemical additive.

19. The system of claim 14 wherein the vibration source comprises an active vibration source.

20. The system of claim 14 wherein the vibration source comprises a passive vibration source.

21. The system of claim 14 wherein the vibration source promotes slurry homogenization by enhancing wetting of the powder source in the slurry.

22. The system of claim 14 wherein the vibration source promotes slurry homogenization by removing air from the slurry.

23. The system of claim 14 wherein the system comprises a wellbore cement slurry mixing system, comprising at least a mixer, a slurry air separator, a mix tub, a recirculation pump, and a delivery pump, and wherein the downstream point comprises a wellbore.

24. The system of claim 14 wherein the at least one vibration source is located in a high-velocity zone in at least one of the recirculation circuit and the system.
